(19) United States
(12) Patent Application Publication
(10) Pub. No.: US 2008/0144692 A1
(43) Pub. Date: Jun. 19, 2008

(54) Electric Arc Furnace

(75) Inventors: Emile Lonardi, Bascharage (LU); Jean-Luc Roth, Thionville (FR); Paul Tockert, Luxembourg (LU)

Correspondence Address: CANTOR COLBURN, LLP, 20 Church Street, 22nd Floor, Hartford, CT, 06103, US

(73) Assignee: PAUL WURTH S.A., Grand Duchy of Luxembourg (LU)

(21) Appl. No.: 11/816,848

(22) PCT Filed: Feb. 28, 2006
(86) PCT No.: PCT/EP06/60337

§ 371 Date: Oct. 23, 2007

(30) Foreign Application Priority Data
Feb. 28, 2005 (LU) 91 142

(51) Int. Cl. F27D 1/12

(52) U.S. Cl. 373/72; 373/76; 373/71

(57) ABSTRACT

An electric arc furnace (10) has an outer shell (12) and an inner refractory lining (24). During its operation the electric arc furnace (10) contains a bath (28) of molten metal which has a minimum and a maximum operational level (32). An inner cooling ring (23) of copper slabs (20), which are in thermo-conductive contact with the inner refractory lining (24) and equipped with spray cooling means (22), is mounted to the outer shell (12) in the region (34) between the minimum and the maximum operational level (32).

### TECHNICAL FIELD

The present invention relates to an electric arc furnace and to a cooling arrangement for the refractory lining of such a furnace. More particularly, the present invention relates to a pig iron smelting electric arc furnace, which produces pig iron with a strongly stirred bath in order to allow a high specific power input (in the order of magnitude of 1 MW/m²), and to a cooling arrangement for cooling the refractory lining in this specific type of pig iron smelting furnace.

### BACKGROUND ART

In a pig iron smelting electric arc furnace, pre-reduced iron and other metallic oxides are molten and reduced in order to produce ferroalloys. During operation, the temperature of the bath of molten metal (i.e. pig iron) in the furnace is normally between 1450° C. and 1550° C. In order to ensure a uniform bath temperature and to permit fast smelting of the input material, the electric arc power needs to be rapidly spread throughout the bath. In the aforementioned type of pig iron smelting furnace, this is achieved by strongly stirring the bath e.g. by means of nitrogen injection through porous plugs.

It is well known in the field of electric steel production that one of the zones of most pronounced refractory deterioration is the zone adjacent the interface between the bath of molten metal and the slag layer on top thereof. Refractory deterioration in this critical zone is due to various chemical, thermal and mechanical effects. Irrespective of the effects, it has been found that refractory deterioration increases with increasing temperature of the refractory lining and in particular of its hot face, i.e. where the refractory is in contact with the molten metal bath or the slag layer. Deterioration of the refractory lining being a significant cost factor, various attempts have been made to provide a cooling arrangement for cooling the refractory lining in the aforementioned critical zone.

In addition, besides the cost factor, there is a significant safety risk related to erosion of the refractory lining. In fact, if molten metal enters into direct contact with the furnace shell due to excessive local erosion of the refractory lining, a molten metal leakage may occur, in particular in the critical zone. This risk is specifically but not exclusively known with regard to pig iron smelting furnaces with strongly stirred and overheated bath. In order to avoid possible leakage of molten metal in case of a localised deficiency of the refractory lining, it is desirable to solidify the molten metal in contact with or prior to being in contact with the furnace shell. Since the bath of molten metal (i.e. pig iron) is strongly stirred and overheated by approximately 300° C. (the melting temperature of pig iron being approx. 1190° C.), it is difficult to solidify the molten metal by means of a cooling device in the aforementioned type of furnace.

It is generally accepted in the field that internal forced water cooling of the refractory lining, which is well known in blast furnaces, is not a viable solution for electric arc furnaces. As a matter of fact, the introduction of cooling liquid into the hot interior of the electric arc furnace implies a severe risk of explosion. This problem can be overcome by external spray cooling of the furnace shell, which is described for example in EP 0 044 512. By cooling the furnace shell externally, a temperature reduction of the refractory lining is achieved. There remains however the risk of a molten metal leakage, in case the refractory lining is excessively deteriorated in the critical zone. U.S. Pat. No. 3,777,043 describes an approach where gaseous coolant is circulated through channels which penetrate the refractory lining in the aforementioned critical zone. Besides the limited efficiency of gas type cooling, this solution requires an expensive installation of cooling channels and gas coolant circuitry and significant modifications in the refractory lining are necessary. A different approach is described in U.S. Pat. No. 3,849,587. In this approach, solid cooling members of high thermal conductivity are placed through the furnace shell and into the refractory lining. The length, cross sectional area, spacing and material of these rod-shaped members is chosen to conduct sufficient heat from the refractory lining. The cooling members can be cooled outside the furnace shell, e.g. by forced water cooling. Although cooling of the refractory lining is achieved with this approach, it has the drawbacks of creating considerable temperature gradients in the refractory lining and weakening the structure of the lining due to the penetration of the lining by the cooling members. A comparable approach is put forward in WO 95/22732 where the problem of the temperature gradients is addressed by multiplying the cooling elements and reducing their cross section. In this approach however, the structure of the lining is also weakened and installation and repair of the refractory lining is rendered even more difficult.

### TECHNICAL PROBLEM

It is an object of the present invention to provide an electric arc furnace having an improved cooling arrangement which reduces or overcomes the aforementioned problems.

### GENERAL DESCRIPTION OF THE INVENTION

To achieve this object, the present invention proposes an electric arc furnace which comprises an outer shell and an inner refractory lining and contains a bath of molten metal during its operation. This bath of molten metal has a minimum and a maximum operational level. According to an important aspect of the present invention, a ring of copper slabs is mounted to the outer shell, in the region between the minimum and the maximum operational level and the copper slabs are in thermo-conductive contact with the inner refractory lining in this region between the minimum and the maximum operational level. According to another important aspect, the copper slabs are equipped with spray cooling means. The copper slabs are generally flat and comparatively thick pieces of solid material, i.e. without any cavities and in particular without internal cooling channels. According to the requirements, at least one of the faces of the copper slab may be curved but their longitudinal section is generally square or rectangular. Their height normally exceeds the vertical distance between the minimum and maximum operational level and they are mounted such that these operational levels are situated within an actively cooled area of the copper slabs. The copper slabs are mounted inside the outer shell where they constitute an inner cooling ring. They are in thermo-conductive contact with the refractory lining in the critical zone between the minimum and maximum operational level of the molten metal bath. Heat is dissipated by spray cooling of the copper slabs, such that a significant reduction in the temperature of the refractory lining in the critical zone is insured without creating a risk of explosion due to liquid entering the furnace. As will be appreciated, the present invention is equally applicable to alternating current (AC) and direct current (DC) electric arc furnaces.

In a preferred embodiment, the copper slabs are solid bodies having a smooth front face in contact with the inner refractory lining and a curved rear face for external rear cooling by the spray cooling means. The front and the rear face, which are respectively turned to the inside and the outside of the furnace, form the large faces of the body which has approximately the shape of a hexahedron or parallelepiped (except for the curved rear face). The copper slabs are mounted such that their front and rear faces are essentially vertical. The smooth front face allows for an efficient thermo-conductive contact with the refractory lining. The smooth front face is conjugated to the outer surface of the refractory lining and more specifically with to the normally flat or curved outer surface of the refractory bricks of the lining. As will be appreciated, both during construction and during repair, the refractory bricks can be easily placed contiguous to the smooth front face and no cutting or drilling of the refractory bricks is required. The curved rear face is adapted to the curvature of the normally cylindrical outer furnace shell.

Advantageously, the outer shell is provided with a corresponding rear cooling aperture for each of the copper slabs. The individual rear cooling apertures are dimensioned such that the copper slabs can be directly mounted to the remaining portion of the outer shell so as to overlap the aperture. Although larger apertures for a plurality of copper slabs could be envisaged, least possible weakening of the shell structure and facilitated sealing is insured by individual rear cooling apertures. In case of retrofitting an existing electric arc furnace, reinforcement means for reinforcing the outer steel shell may be installed prior to providing the rear cooling apertures.

In a preferred embodiment, a plurality of copper slabs are adjacently mounted to the inside of the outer shell so as to form a substantially continuous ring. Normally, the ring needs to be interrupted only at the location of the slag notch and the taphole of the electric arc furnace. With only these interruptions, maximum peripheral coverage by the inner cooling ring is obtained. In combination with the given height of the copper slabs, temperature gradients in the critical region of the refractory lining are reduced.

A temperature sensor is preferably associated to each of the copper slabs for monitoring the effective temperature of the copper slabs, in particular during operation of the furnace. Temperature information allows to obtain information on the condition of the refractory lining beforehand, without the need for an inspection shutdown. Using temperature measurements on each of the copper slabs, a circumferential profile regarding the state of thermal isolation of the furnace in general, and the condition of the remaining refractory lining in particular, can be established. Temperature information can also be used in process control of the electric arc furnace and the cooling arrangement in particular.

Advantageously, the width of the copper slabs is less than or equal to lm. Refractory deterioration is relatively unpredictable today, in particular in electric arc furnaces of the type with strongly stirred and/or overheated bath. Providing a sufficient number of copper slabs over the circumference of the furnace, each having a dedicated temperature sensor, insures a reliable detection of any local temperature increase on the furnace periphery. In fact, such an increase is indicative of refractory deterioration and thus of an imminent molten metal leakage. Since deterioration of the refractory is unpredictable, a local heating of the furnace shell known as “hot spot” can occur in furnaces devoid of the cooling ring as herein described. Until now such “hot spots” have often resulted in molten metal leakage and the related dangerous consequences. Detection of a temperature increase allows to establish an early warning system in order to avoid possible accidents. Moreover, preventive measures such as repair measures (e.g. gunning or “shotcreting” of the refractory lining) can be carried out effectively and in targeted manner since a detected temperature increase is well located.

In order to collect the spray cooling fluid and in order to warrant minimal pollution thereof, e.g. by flue dust, each of said copper slabs is preferably provided with a cooling box. Use of closed boxes on the rear face of the copper slabs is particularly advantageous where a closed cycle cooling circuit is required. The cooling boxes may be openable for inspection and maintenance purposes. The cooling boxes are preferably mounted to said copper slabs so as to protrude to the outside of said outer shell. This arrangement renders the rear face of the copper slabs and the associated spray cooling means easily accessible from outside the furnace, e.g. for inspection or maintenance purposes.

Beneficially, a spray cooling nozzle is removably mounted to a rear cover of said cooling box. The cooling box thus provides the dual function of protective housing and mounting structure for the spray cooling nozzle. In order to warrant free flowing discharge of the spray cooling fluid, the cooling box preferably comprises a discharge connection and an air admission.

Advantageously, the copper slabs have a thickness of 20 to 80 mm and preferably 50 to 60 mm. It may be noted that this thickness indication refers to the spot of maximum wall thickness, e.g. in case the front or rear face has been machined to present a certain curvature. This range is chosen as a compromise between maximizing the thickness for safety and constructive reasons and minimizing the thickness for efficient heat transfer. In fact, a thin slab is in favour of a desirable minimal thermal resistance whereas a thick slab is in favour of an equally desirable maximum instantaneous thermal absorption capacity, e.g. for solidifying molten metal, in particular (overheated) pig iron.

High cooling efficiency is obtained with copper slabs made of pure copper or a copper alloy having a thermal conductivity exceeding that of the outer shell by a factor of at least five.

The aforementioned embodiments are particularly applicable to a pig iron smelting electric arc furnace of the type with strongly stirred and/or overheated bath. In such furnaces refractory erosion and the related risk of molten metal (i.e. molten pig iron) leakage are particularly pronounced inter alia because of the high thermal load inherent to these types of furnace. In fact, the ring of copper slabs as described hereinbefore is capable of withstanding the adverse conditions in these furnaces.

As will be appreciated by those skilled in the art, the cooling arrangement with the ring of copper slabs as described above can be retrofitted to virtually any existing electric arc furnace without requiring excessive modifications. In particular, installation of the inner cooling ring requires only small modifications in the structure of the refractory lining.

### DETAILED DESCRIPTION WITH RESPECT TO THE FIGURES

Further details and advantages of the present invention will be apparent from the following description of a not limiting embodiment with reference to the attached drawings, wherein:

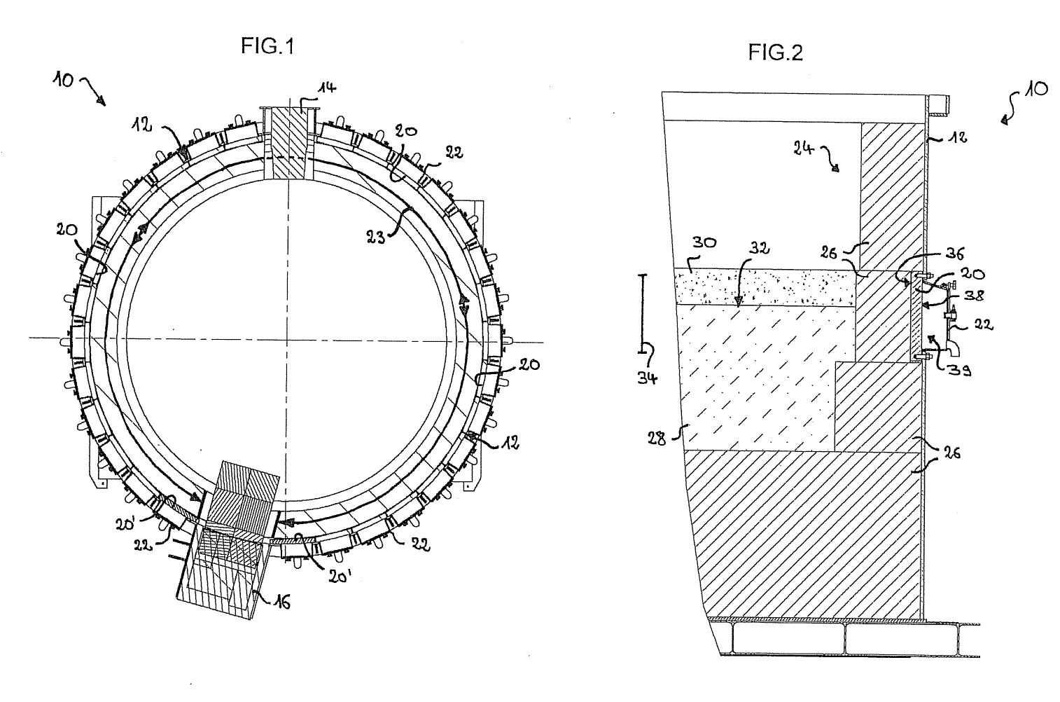

FIG. 1 is a horizontal cross sectional view of an electric arc furnace showing an inner cooling ring;

FIG. 2 is a partial vertical cross sectional view of a portion of the electric arc furnace of FIG. 1 during operation;

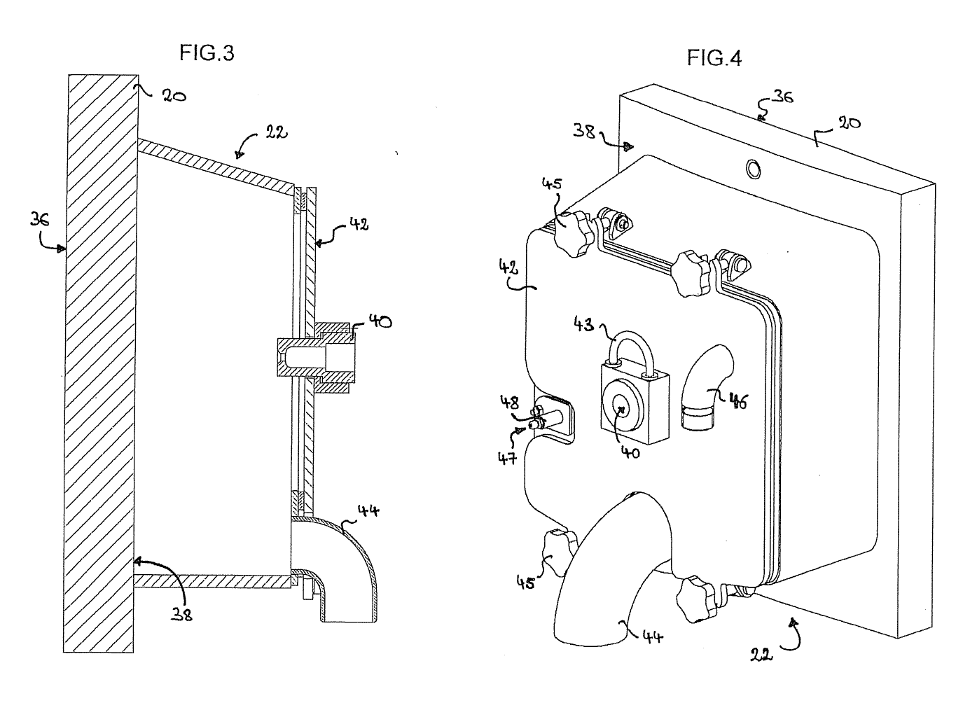

FIG. 3 is an enlarged vertical cross sectional view showing a copper slab equipped with spray cooling means;

FIG. 4 is a perspective view of the copper slab equipped with spray cooling means according to FIG. 3;

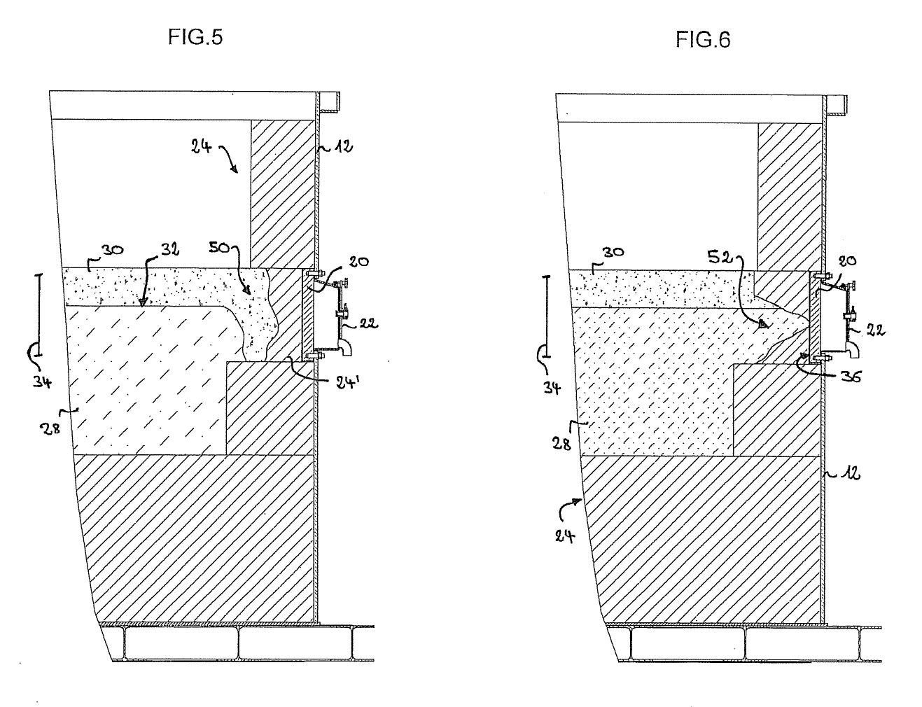

FIG. 5 is a partial vertical cross sectional view according to FIG. 2 showing a first type of refractory lining defect;

FIG. 6 is a partial vertical cross sectional view according to FIG. 2 showing a second type of refractory lining defect.

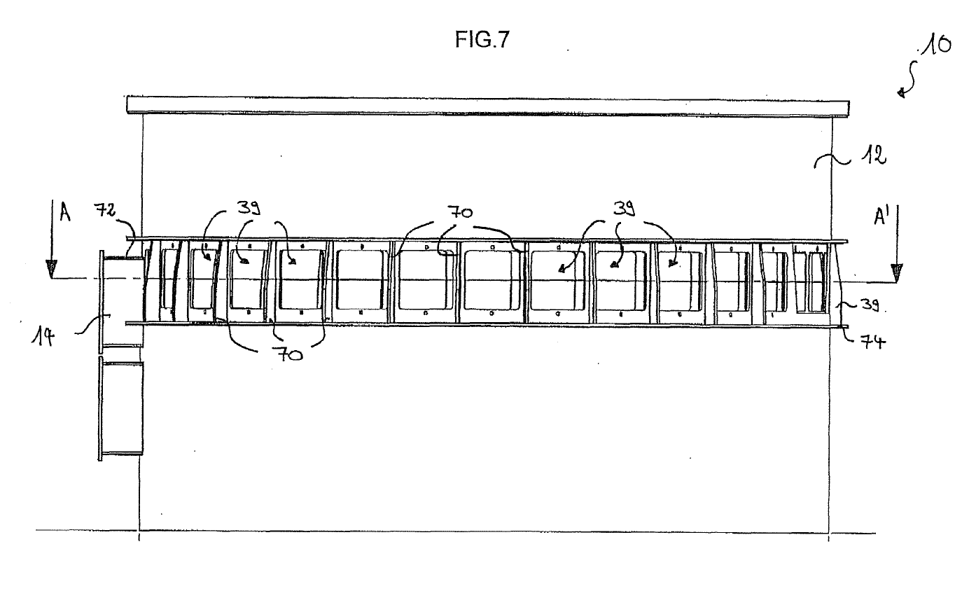

FIG. 7 is a perspective side view of the electric arc furnace of FIG. 1 without the inner cooling ring being installed.

FIG. 1 shows a horizontal cross section of an electric arc furnace generally identified by reference numeral 10. A cylindrical outer furnace shell 12, which is made of welded steel plates, is inwardly lined with refractory material. The section of FIG. 1 passes through a taphole block 14 for discharging molten metal and it also shows a slag door 16 for discharging slag formed on top of the bath of molten metal during operation.

As seen in FIG. 1, a plurality of copper slabs 20, 20′ are mounted to the inside of the outer shell 12. Each of the copper slabs 20, 20′ is equipped with a cooling box 22. The copper slabs 20, 20′ are adjacently mounted so as form an essentially continuous inner cooling ring indicated by circular arrow 23. The inner cooling ring 23 uniformly cools a specific region of the refractory lining (not shown in FIG. 1) during operation of the electric arc furnace 10. It may be noted that, for constructive reasons, the inner cooling ring 23 is interrupted by the taphole block 14 and the slag door 16. Except for the copper slabs 20′ having a shape specifically adapted to the circumstances at the location of the slag door 16, the copper slabs 20 generally have the same configuration. The copper slabs 20′ are tangentially elongated towards the slag door 16 so as to closely approach the latter.

The configuration of the copper slabs 20, 20′ and their associated spray cooling means will be more apparent from FIG. 2. FIG. 2 shows an inner refractory lining 24 of the outer shell 12 in the lower part of the electric arc furnace 10, i.e. in the furnace hearth. In a manner known per se, the refractory lining 24 is made of refractory bricks 26. The refractory lining 24 protects the outer shell 12 against a bath of molten metal 28 and a molten slag layer 30 and prevents leakage of any of the latter. As is well known, the molten metal level indicated at 32 may vary during operation between an upper maximum and a lower minimum operational level as indicated by vertical range 34. The copper slabs 20, 20′ are arranged in the region given by this range 34 and protrude to some extent above and below the range 34 with their respective upper and lower ends. As will be appreciated, a relatively uniform temperature profile of the refractory lining 24 in and around the range 34 is warranted since the inner cooling ring 23 extends circumferentially over essentially the entire periphery of the refractory lining 24 and vertically over its critical deterioration zone. Accordingly, any thermal stresses due to vertical and tangential temperature gradients in the refractory lining 24 are significantly reduced in this zone.

The copper slab 20 shown in FIG. 2 is a solid body without cavities made of copper or a copper alloy having high thermal conductivity (>300 W/Km). The copper slab 20 has a large front face 36 which is in contact with the inner refractory lining 24 and a large rear face 38 which is accessible for external rear cooling of the copper slab 20. It may be noted that the front face 36 of the copper slab 20 is smooth so as to warrant an efficient thermo-conductive contact with the refractory brick(s) 26. In this embodiment, the front face 36 is flat because the refractory brick(s) 26 have a flat rear side. Depending on the form of the refractory brick(s) 26, other shapes are however not excluded. In fact, during operation of the electric arc furnace 10, the thermo-conductive contact between the refractory brick(s) 26 and the copper slab 20 is reinforced by thermal dilatation. The cooling box 22 is made of any suitable material and sealingly fixed to the rear face 38 e.g. by means of welding. The border of the rear face 38 is sealingly fixed to the inside of the outer shell 12, e.g. by means of screw bolts. As seen in FIG. 2, the copper slab 20 overlaps a corresponding rear cooling aperture 39 provided in the outer shell 12. The rear cooling aperture 39 provides access to the copper slab 20 for external spray cooling thereof.

As best seen in FIG. 3, a spray cooling nozzle 40 is fixed on a removable rear cover 42 of the cooling box 22. During operation, the spray cooling nozzle 40 sprays a cooling fluid onto the rear face 38 of the copper slab 20. The cone angle of the spray cooling nozzle 40 is approximately 120° such that the spray covers the entire part of the rear face 38 covered by the cooling box 22, which part forms the actively cooled area of the copper slab 20. Any excess of cooling fluid in the cooling box 22 is immediately discharged through the discharge connection 44 such that only a small amount of liquid cooling fluid is within the cooling box 22 at any given time.

As shown in FIG. 4, a removable U-shaped retention 43 allows to withdraw the spray cooling nozzle 40 from its supporting seat in the rear cover 42. This renders the spray cooling nozzle 40 easily accessible for inspection, maintenance or replacement. The rear cover 42 can be easily flipped open by means of hand screws 45 for accessing the interior of the cooling box 22, e.g. for inspection or maintenance purposes. As further seen in FIG. 4, the rear face 38 of the copper slab 20 is slightly curved in a manner adapted to the curvature of the cylindrical outer shell 12. The curved rear face 38 allows to sealingly mount the copper slab 20 to the inside of the outer shell 12 by warranting a uniform contact pressure for an intermediate flange gasket (not shown). The dimensions of the copper slab 20 chosen in a specific example were: height 490 mm, width 425 mm and maximum depth (wall thickness) 60 mm. These dimensions depend however on the characteristics of the respective electric arc furnace and shall be considered as a purely illustrative. An air admission 46 is provided in the rear cover 42 of the cooling box 22. The air admission 46 warrants free discharging of the cooling fluid out of the cooling box 22 independent of the operation of the spray cooling nozzle 40. A connection to a temperature sensor 47 is provided on the cooling box 22 for measuring the temperature of the copper slab 20. The temperature sensor 47 is mounted in thermo-conducting manner into a bore (not shown) in the copper slab 20 and protected against the cooling fluid by means of a protective sheath 48. It may be noted that, except for the width, the configuration and characteristics of the copper slabs 20′ generally correspond to those of the copper slab 20 detailed above.

The temperature measurements obtained by means of the temperature sensor 47 allow controlling the cooling effectiveness in function of the effective temperature of the copper slab 20, 20′. Since every copper slab 20, 20′ is provided with a dedicated temperature sensor 47, the cooling effectiveness can be locally adapted according to the circumferential temperature profile of the electric arc furnace 10. Moreover the total cooling fluid flow can be optimised according to the current operating conditions. In addition, the temperature measurements allow to obtain (a priori) information on the current condition of the refractory lining 24 during operation. Control equipment for the above purposes is well known in the field of automatic control engineering and will not be detailed here.

Turning back to FIG. 1 and FIG. 2, it is well known in metallurgy, that one of the areas of most severe erosion of the refractory lining (such as 24) in an electric arc furnace (such as 10) is the region between the minimum and maximum operational level of the molten metal (indicated by range 34). It is also well known that this erosion depends on the temperature of the refractory lining (such as 24) in this region (indicated by range 34). This also applies to the formation of cracks and subsequent penetration of metal into the refractory lining (such as 24), which is another detrimental effect causing deterioration of the refractory. When compared to known external cooling of the furnace shell itself (see for example EP 0 044 512), the inner cooling ring 23 of spray cooled copper slabs 20, 20′ insures more effective cooling of the inner refractory lining 24 in this critical region of range 34. In fact, due to the high thermal conductivity of the copper slabs 20, 20′ (approx. 350-390 W/Km) when compared to the thermal conductivity of the outer shell 12 made of steel (approx. 45-55 W/Km), the amount of heat that can be dissipated through the copper slabs 20, 22′ over a given time and surface is significantly higher than what can be dissipated through the outer shell 12 made of steel. As will be appreciated, this improvement is achieved without introducing the risk of explosions implied by other known types of forced cooling circuits. Even in the improbable case of a breakdown of one of the copper slabs 20, 20′, i.e. a leakage of hot metal or slag, the little amount of liquid cooling fluid remaining within the cooling box 22 immediately evaporates without causing a risk of explosion. Accordingly, any notoriously dangerous inclusion of cooling liquids in the molten metal or slag is avoided with the cooling arrangement as shown in FIG. 1 and FIG. 2. Furthermore, since the inner cooling ring 23 is almost vertically level with the inside of the outer shell 12, this improvement is achieved without causing structural weakening of the refractory lining 24 by protruding cooling elements penetrating the lining and without requiring significant modifications of the lining.

Turning now to FIG. 5 and FIG. 6, two types of defects in the refractory lining 24 according to FIG. 2 and the function of the spray cooled copper slabs 20, 20′ in these cases will be illustrated below.

In FIG. 5, part of the refractory lining 24 in the region of range 34 is significantly eroded or worn off, e.g. after a significant time of operation of the electric arc furnace 10 without repair of the refractory lining 24. As seen in the refractory lining 24 of FIG. 5, an eroded zone indicated at 50 is filled with slag originating from the slag layer 30. Due to the effective cooling by means of the spray cooled copper slabs 20, 20′, the slag contained in the zone 50 can be cooled down below its melting point so as to solidify on a remaining refractory layer 24′ in front of the copper slab 20, 20′. As a result, the inner cooling ring 23 of FIG. 1 allows “hot patching” or repairing of the refractory lining 24 in the region of range 34, even during operation of the electric arc furnace 10. In order to promote solidification of slag in the zone 50, the operational level 32 of molten metal corresponding to the lower slag level may be actively influenced, e.g. varied over the range 34, so as to run a “slag lining” repair cycle for covering the remaining refractory layer 24′ with a layer of solidified slag. This process may be used to provide temporary repair but may also contribute to a significant lengthening of the refractory reconstruction interval.

FIG. 6 shows a more extreme type of defect in the refractory lining 24. A particularly eroded zone indicated at 52 in the refractory lining 24 of FIG. 6 extends horizontally to the front face 36 of the copper slab 20. In the disadvantageous situation as shown in FIG. 6, this zone 52 is filled with molten metal originating from the bath of molten metal 28. It will be appreciated that the copper slab 20 can prevent leakage of molten metal even in this adverse situation. It may be noted that, due to the high thermal conductivity of copper, the temperature of the front face 36 is only slightly higher than that of the rear face 38 during heat transfer. The combined effect of the high thermal conductivity of copper and the relative thickness (i.e. thermal absorption capacity) of the copper slabs 20, 20′ allows to layer of molten metal in front of the copper slab 20 in a situation as shown in FIG. 6. Once created, this solidified layer of metal acts as a thermal insulation protecting the copper slab 20 from melting. In contrast, in a situation where the outer shell 12 itself is in direct contact with molten metal, there may very well occur a dangerous leakage due to the relatively poor thermal conductivity and the thinness of the outer steel shell 12. As a result, the inner cooling ring 23 allows to solidify not only molten slag but also molten metal in the region of range 34, even if the refractory lining 24 is eroded up to one or more copper slab(s) 20, 20′. In this way, the inner cooling ring 23 also contributes to operational safety of the electric arc furnace 10.

FIG. 7 shows the rear cooling apertures 39 in the lower part of electric arc furnace 10 in more detail. As seen in FIG. 7, reinforcement ribs 70 are vertically welded to the outer shell 12 in between the rear cooling apertures 39. An upper flanged ring 72 and a lower flanged ring 74 are horizontally welded to the outer shell 12, above and the below the rear cooling apertures 39 respectively. The reinforcement ribs 70 are also fixed with their respective upper and lower ends to the upper and lower flanged ring 72 and 74 respectively. As will be appreciated, the reinforcement ribs 70 together with the flanged rings 72, 74 provide a rigid structural reinforcement of the outer shell 12 which is weakened due to the rear cooling apertures 39. In addition it may be noted that, although the copper slabs 20,20′ are not shown, FIG. 7 indicates the plane AA′ of FIG. 1.

Electric arc furnaces equipped with a movable furnace hearth, i.e. in which the lower furnace shell that is inwardly lined with refractory lining is movable, are well known. Among others, they allow the hearth to be replaced e.g. when refurbishment of the refractory lining is required. Obviously, cooling action by means of the cooling ring 23 should also be available during transportation of the furnace hearth, during cooling-down prior to refurbishment and/or during preheating after refurbishment. If water supply of the spray cooling nozzles 40 and guided discharge from the discharge connections 44 were to be ensured also during transportation of the hearth, transportation would be impeded and an expensive and complex conduit system capable of adapting to the transportation path would be required. Therefore, two supplementary cooling procedures shall be presented below, which are intended to be employed in case the electric arc furnace 10 has a movable furnace hearth, i.e. a movable lower furnace shell 12, and take advantage of the cooling ring 23 according to the present invention.

A first possible method comprises the following aspects. A common discharge conduit, which forms the outlet of a collector (not shown) that is connected the discharge connections 44, is shut and disconnected. As a result, the cooling boxes 22 form a ring of communicating containers. The cooling boxes 22 are filled with water. Filling the cooling boxes 22 with water does not represent a safety risk in this case, because the movable furnace hearth is emptied of molten metal prior to transportation. The amount of water contained in the filled cooling boxes 22 is normally sufficient to warrant cooling during transportation. Optionally, e.g. in case considerable time is required for transportation, the cooling boxes 22 may operate in an evaporation cooling mode. To this effect, some of the cooling boxes are equipped with a low level detector, a high level detector and a water supply conduit. When the water level in the cooling boxes drops below the low level, the cooling ring 23 will be supplied with additional water through the one or more supply conduits until the high level is reached. The above method may also be used during transportation of the furnace hearth from its refurbishment position back to its operating position. During the cooling-down phase, e.g. prior to refurbishment, and the heating-up or preheating phase, e.g. after refurbishment, the cooling ring 23 can be operated in spray cooling mode as described above.

In a second possible method, the cooling boxes 22 are filled with water during transportation and during the cooling-down and the preheating phases. As described above, the one or more common discharge conduit(s) are shut such that the cooling boxes 22 form communicating containers and the cooling boxes 22 are filled with water. In addition to a low level detector and a high level detector, some of the cooling boxes are equipped with temperature sensors for measuring the water temperature inside the cooling boxes 22. An auxiliary water supply conduit and an auxiliary discharge conduit of reduced diameter are provided for filling respectively emptying the communicating cooling boxes 22. In this second method, the water temperature in the cooling boxes is controlled so as to have a value within a certain range e.g. in between 60°-80° C. When the upper temperature limit is reached, hot water in the cooling boxes 22 is discharged until the water level reaches the low level, preferably set well below half the height of the cooling boxes 22. Cool water is added to the cooling boxes 22 until the high level is reached whereby the water temperature is reduced. Since the thermal loads during cooling-down and preheating are significantly lower than during operation, it will be appreciated that the required supply and discharge flow rates remain relatively small.

1-14. (canceled)

15. A pig iron smelting electric arc furnace comprising:
an outer shell with rear cooling apertures arranged in an annular zone of said outer shell between a minimum and maximum operational level of a liquid metal bath to be received in said furnace;
a ring of relatively thick copper slabs mounted to said outer shell so as to cover said rear cooling apertures, each of said copper slabs having a front side and a rear side;
spray cooling means for cooling said rear sides of said copper slabs; and
an inner refractory lining of said outer shell, wherein said inner refractory lining is in thermo-conductive contact with said front sides of said copper slabs.

16. The electric arc furnace as claimed in claim 15, wherein said copper slabs are solid bodies having a smooth front face in contact with said inner refractory lining and a curved rear face for external rear cooling by said spray cooling means.

17. The electric arc furnace as claimed in claim 15, wherein a corresponding rear cooling aperture is provided in said outer shell for each of said copper slabs.

18. The electric arc furnace as claimed in claim 15, wherein a plurality of said copper slabs are adjacently mounted to the inside of said outer shell so as to form a substantially continuous ring.

19. The electric arc furnace as claimed in claim 15, wherein said copper slabs have a thickness of at least 20 mm.

20. The electric arc furnace as claimed in claim 15, wherein said copper slabs have a thickness of 50 to 60 mm.

21. The electric arc furnace as claimed in claim 15, wherein a temperature sensor is associated to each of said copper slabs.

22. The electric arc furnace as claimed in claim 21, wherein the width of said copper slabs is less than or equal to 1 m.

23. The electric arc furnace as claimed in claim 15, wherein said copper slabs are made of pure copper or a copper alloy having a thermal conductivity exceeding that of the outer shell by a factor of at least five.

24. A pig iron smelting electric arc furnace comprising:
an outer shell with rear cooling apertures arranged in an annular zone between a minimum and maximum operational level of a liquid metal bath to be received in said furnace, said outer shell having an inside and an outside;
a ring of relatively thick copper slabs mounted to said inside of said outer shell so as to cover said rear cooling apertures, each of said copper slabs having a front side and a rear side;
cooling boxes mounted to said copper slabs so as to protrude through said rear cooling apertures outside of said outer shell;
spray cooling means arranged in said cooling boxes for cooling said rear sides of said copper slabs; and
an inner refractory lining of said outer shell, wherein said inner refractory lining is in thermo-conductive contact with said front sides of said copper slabs.

25. The electric arc furnace as claimed in claim 24, wherein said spray cooling means comprise a spray cooling nozzle which is removably mounted to a rear cover of said cooling box.

26. The electric arc furnace as claimed in claim 24, wherein said cooling box comprises a discharge connection and an air admission.

27. The electric arc furnace as claimed in claim 24, wherein said copper slabs have a thickness of at least 20 mm.

28. The electric arc furnace as claimed in claim 24, wherein said copper slabs have a thickness of 50 to 60 mm.

29. The electric arc furnace as claimed in claim 24, wherein a temperature sensor is associated to each of said copper slabs.

30. The electric arc furnace as claimed in claim 30, wherein the width of said copper slabs is less than or equal to 1 m.

31. The electric arc furnace as claimed in claim 24, wherein said copper slabs are made of pure copper or a copper alloy having a thermal conductivity exceeding that of the outer shell by a factor of at least five.
